(19) United States
(12) Patent Application Publication
(10) Pub. No.: US 2026/0150020 A1
(43) Pub. Date: May 28, 2026

(54) RANK BASED NEIGHBOR SELECTION FOR MULTI LAYER MANAGEMENT (MLM) BLIND HANDOVER

(71) Applicant: Rakuten Symphony, Inc., Tokyo (JP)

(72) Inventors: Hanumantappa KORACHARA MAREPPA, Karnataka (IN); Gugan ILANGOVAN, Karnataka (IN); Raghul SUNDARAVARADHAN, Karnataka (IN); Santhiyaku Jeevakumar ANTONYRAJ, Karnataka (IN)

(73) Assignee: Rakuten Symphony, Inc., Tokyo (JP)

(21) Appl. No.: 19/078,679

(22) Filed: Mar. 13, 2025

(30) Foreign Application Priority Data
Nov. 28, 2024 (IN) 202411093297

(51) Int. Cl. H04W 36/00

(52) U.S. Cl. CPC H04W 36/00837

(57) ABSTRACT

A method for rank based neighbor selection for MLM blind handover is disclosed. The method includes receiving, from a Base station (BS), a blind Handover (HO) list and a plurality of parameters corresponding to a plurality of neighboring cells associated with a serving cell in connection with the BS, wherein the plurality of parameters comprises an initial weight associated with each of the plurality of neighboring cells in the blind HO list. Further, the method includes computing a rank for each of the plurality of neighboring cells in the blind HO list based on the plurality of parameters, updating the initial weight associated with each of the plurality of neighboring cells based on the corresponding computed rank, updating the blind HO list based on the updated weight associated with each of the plurality of neighboring cells, and transmitting the updated blind HO list to the BS to perform a HO.

### CROSS REFERENCE TO RELATED APPLICATION(S)

This application claims priority based on India patent application No. 202411093297 filed Nov. 28, 2024, the entire disclosure of which is incorporated by reference herein.

### FIELD

The present disclosure relates to rank based neighbor selection for Multi Layer Management (MLM) blind handover.

### BACKGROUND

The information disclosed in this background section is only for enhancement of understanding of the general background of the disclosure and should not be taken as an acknowledgement or any form of suggestion that this information forms the prior art already known to a person skilled in the art.

Multi-frequency bands are a key aspect of fourth-generation (4G), fifth-generation (5G) and sixth-generation (6G) wireless systems, as the multi-frequency bands can improve network capacity and quality. For example, 5G systems can use a combination of existing 4G bands and higher frequency mmWave bands. Accordingly, the frequency bands may be divided into lower frequency bands and higher frequency bands in a wireless network. The lower bands are generally utilized for coverage and typically have smaller channel bandwidth (CBW). The higher bands have more CBW and are preferred for capacity/performance. In a network with multi-frequency bands, a handover (HO) is performed using an A1-based blind HO process. In this approach, an A1 event is configured for each selected frequency. Additionally, a list of neighboring cells, along with their respective weights, is maintained for each frequency based on the deployment. When the A1 event for a specific frequency is reported by a user equipment (UE), a neighboring cell is chosen using a weight-based round-robin algorithm, and a blind handover is initiated to that selected cell.

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to one embodiment of the present disclosure, a method is disclosed. The method includes receiving, by a radio access network (RAN) intelligent controller (RIC) from a base station (BS), a blind Handover (HO) list and a plurality of parameters corresponding to a plurality of neighboring cells associated with a serving cell in connection with the BS. The plurality of parameters includes an initial weight associated with each of the plurality of neighboring cells in the blind HO list. Further, the method includes computing, by the RIC, a rank for each of the plurality of neighboring cells in the blind HO list based on the plurality of parameters. The method further includes updating, by the RIC, the initial weight associated with each of the plurality of neighboring cells in the blind HO list based on the corresponding computed rank. The method also includes updating, by the RIC, the blind HO list based on the updated weight associated with each of the plurality of neighboring cells.

According to one embodiment of the present disclosure, an apparatus is disclosed. The apparatus is configured to receive, from a base station (BS), a blind Handover (HO) list and a plurality of parameters corresponding to a plurality of neighboring cells associated with a serving cell in connection with the BS. The plurality of parameters includes an initial weight associated with each of the plurality of neighboring cells in the blind HO list. The apparatus is further configured to compute a rank for each of the plurality of neighboring cells in the blind HO list based on the plurality of parameters. The apparatus is also configured to update the initial weight associated with each of the plurality of neighboring cells in the blind HO list based on the corresponding computed rank. The apparatus is further configured to update the blind HO list based on the updated weight associated with each of the plurality of neighboring cells.

According to one embodiment of the present disclosure, a non-transitory computer-readable medium is disclosed. The non-transitory computer-readable medium stores instructions. The instructions include one or more instructions that are executed by a radio access network (RAN) intelligent controller (RIC). The RIC includes one or more processors. The instructions cause the one or more processors to receive, from a base station (BS), a blind Handover (HO) list and a plurality of parameters corresponding to a plurality of neighboring cells associated with a serving cell in connection with the BS. The plurality of parameters includes an initial weight associated with each of the plurality of neighboring cells in the blind HO list. The one or more instructions further cause the one or more processor to compute a rank for each of the plurality of neighboring cells in the blind HO list based on the plurality of parameters. The instructions further cause the one or more processor to update the initial weight associated with each of the plurality of neighboring cells in the blind HO list based on the corresponding computed rank. The instructions further cause the one or more processor to update the blind HO list based on the updated weight associated with each of the plurality of neighboring cells.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a configuration of a wireless communication network at various sites, according to related art;

FIGS. 2A-2D illustrate signal flow diagrams of a handover (HO) process, according to related art;

FIGS. 3A-3E illustrate signal flow diagrams indicating a failure of the HO process, according to related art;

FIG. 4 illustrates an O-RAN architecture including a near-RT RIC and a non-RT RIC, according to an embodiment of the present disclosure

FIG. 5 illustrates a schematic block diagram of the near-RT RIC for a rank-based neighbor selection for an MLM blind handover, according to an embodiment of the present disclosure;

FIG. 6 illustrates a schematic operational flow diagram of a plurality of modules of an apparatus associated with the near-RT RIC, according to an embodiment of the present disclosure;

FIGS. 7A-7B illustrate signal flow diagrams of reception of a blind HO list and a plurality of parameters, according to an embodiment of the present disclosure;

FIGS. 8A-8D illustrate signal flow diagrams of updating and transmitting the blind HO list, according to an embodiment of the present disclosure;

FIGS. 9A-9D illustrate signal flow diagrams of the HO process, according to an embodiment of the present disclosure;

FIG. 10 illustrates a flowchart depicting a method for the rank-based neighbor selection to perform the MLM blind handover; and

FIG. 11 illustrates a diagram of example components of a wireless communication device, according to an embodiment of the present disclosure.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

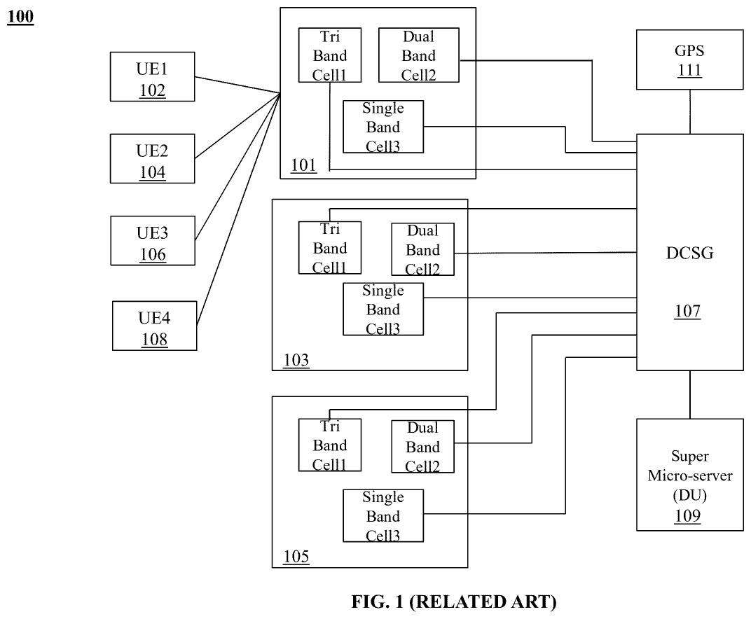

FIG. 1 illustrates a configuration of a wireless communication network 100 at various sites, according to related art. The wireless communication network 100 (also referred to as “the network 100”) may include a plurality of base stations (BSs) (also referred to as eNodeB (eNB)/gNodeB (gNB), 101, 103, and 105 which are served by the network 100. Each of the plurality of BSs 101, 103, and 105 may include a plurality of cells, i.e., a cell 1, a cell2, and a cell3. Each of the plurality of cells may operate on different frequency bands. Further, each of the plurality of cells may be connected to a disaggregated cell site gateway (DCSG) 107. The DCGS 107 may be connected to a Super Micro-server, i.e., a distributed unit (DU) 109 and a global positioning system (GPS) 111. Lower frequency bands are generally utilized for coverage, and such frequency bands typically have smaller channel bandwidth (CBW). Higher frequency bands have relatively high CBW and are preferred for capacity and performance. In a network with multi-frequency bands, improving handover (HO) for an enhanced user experience involves ensuring that a user equipment (UE) is transferred to a frequency or a band where an optimal career aggregation (CA) and an evolved universal terrestrial radio access network (E-UTRAN) new radio-dual connectivity (ENDC) can be activated for the user. Such an approach aims to hand over the user to the frequency or the band that is likely to provide the best possible user experience. In such type of the network, the HO is performed using an A1-event based blind HO process. In this approach, an A1-event is configured for each selected frequency. Additionally, a list of neighboring cells, along with corresponding weights, is maintained for each frequency based on the deployment. For example, when a list of neighboring cells associated with the BS1 101 corresponding to each frequency band is maintained, a list of cells associated with the BS2 103 and the BS3 105 may be considered. Further, when the A1-event for a specific frequency is reported by the UE, a neighboring cell is selected using a weight-based round-robin algorithm, and a blind HO may be initiated to that selected cell.

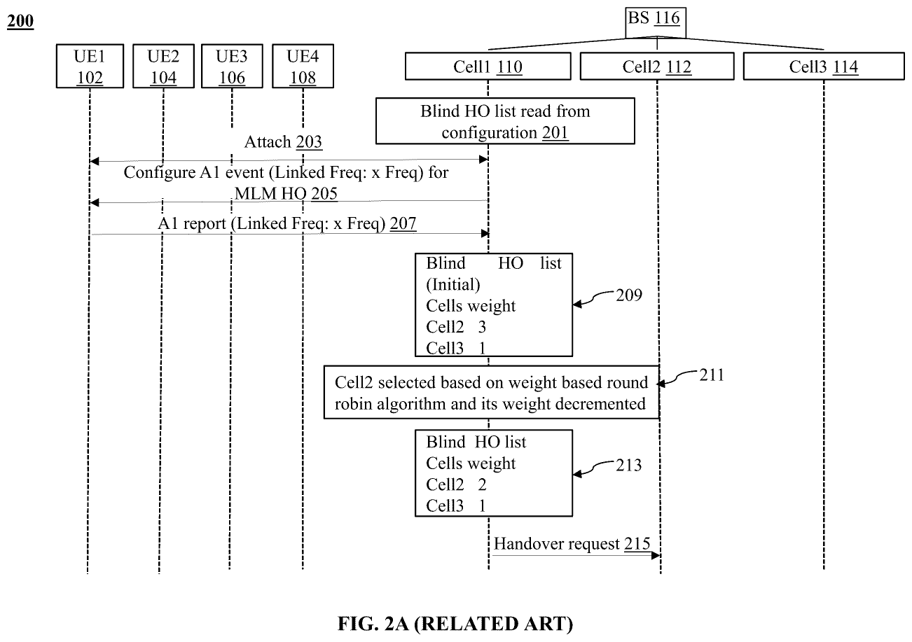

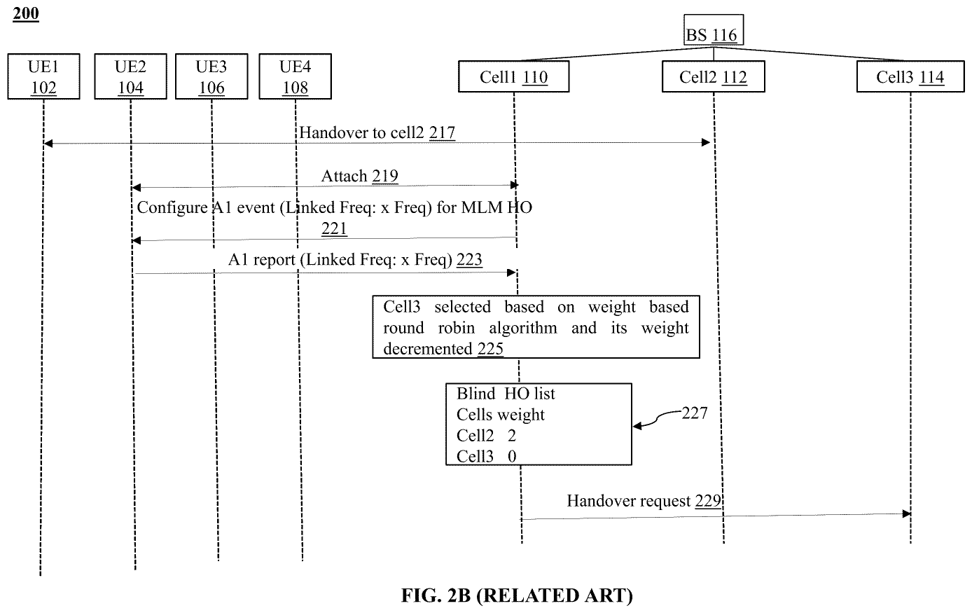

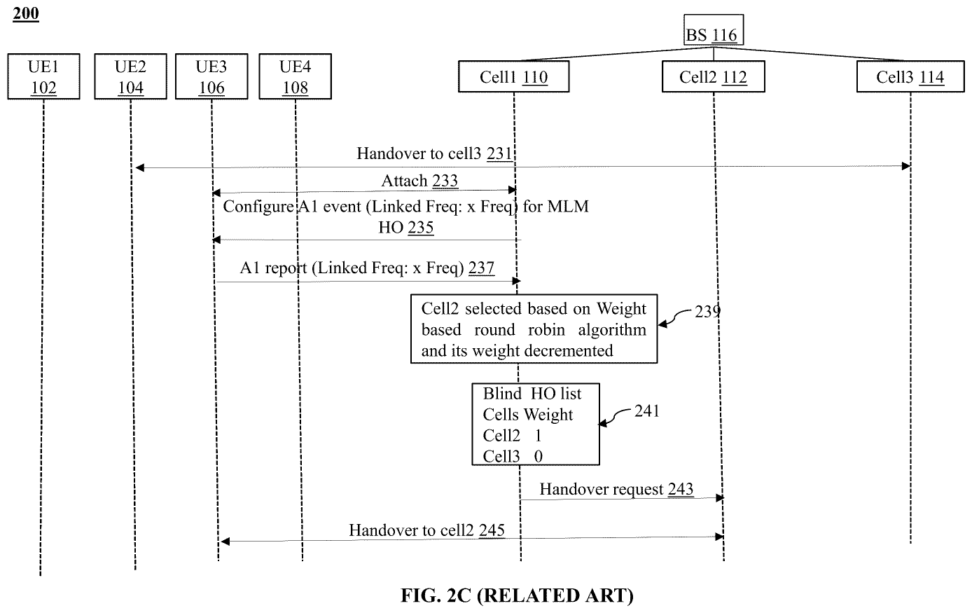

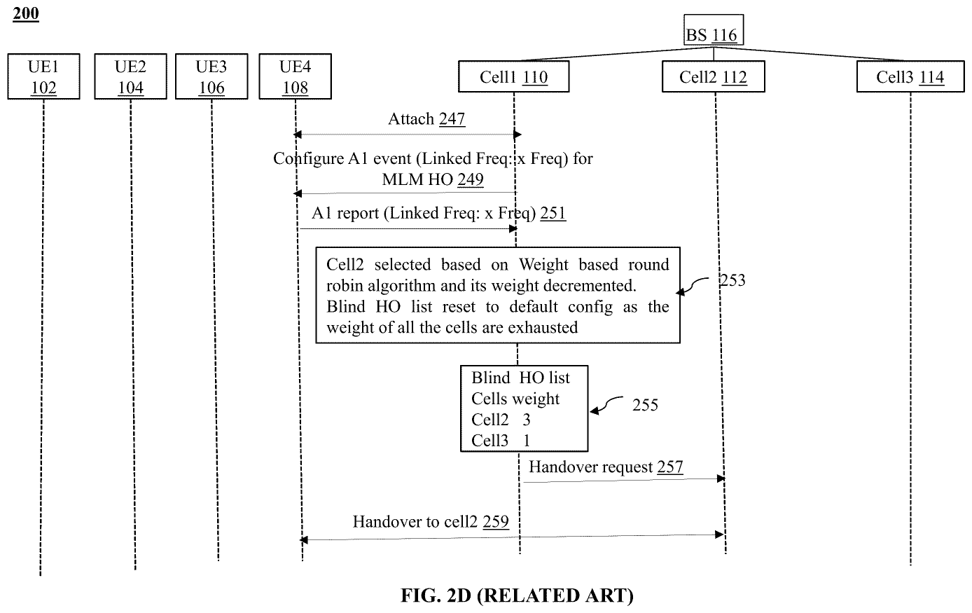

However, the method overlooks a handover success rate associated with a cell during the selection of such cell. Consequently, there is a risk of a handover failing for the selected cell, which may lead to multiple A1-based HOs being unnecessarily triggered from a source cell. This, in turn, can negatively impact operator's key performance indicators (KPIs). For example, the UE1 102 may attempt to handover to the cell1 associated with the BS2 103 even if the handover success rate of the cell1 associated with the BS2 103 is zero, which will result in the failure of HO. Such an HO process is explained in reference to FIGS. 2A-2D.

FIGS. 2A-2D illustrate signal flow diagrams 200 of the HO process, according to related art. cell2 112 and cell3 114 may operate on the same frequency (x). As shown, at operation 201, the cell1 110 reads the Blind HO list read from configuration. At operation 203, the UE1 102 performs an attach process with the cell1 110. At operation 205, the UE1 102 receives configure an A1 event (Linked Freq: x Freq) for MLM HO from the cell1 110. At operation 207, the UE1 102 transmits an A1 report (Linked Freq: x Freq) to the cell1 110. At operation 209, the cell1 110 may refer to the blind HO list, as shown in Table 1:

TABLE 1

| Cells | Weight |
|---|---|
| Cell2 | 3 |
| Cell3 | 1 |

At operation 211, the cell2 112 is selected based on a weight based round robin algorithm and the weight of the cell2 112 is decremented by 1. Further, at operation 213, the weight of the cell2 112 is updated, as shown in Table 2:

TABLE 2

| Cells | Weight |
|---|---|
| Cell2 | 2 |
| Cell3 | 1 |

At operation 215, the cell1 110 transmits a HO request to the cell2 112. At operation 217, the UE1 102 performs handover with the cell2 112. At operation 219, the UE2 104 performs the attach process with the cell1 110. At operation 221, the UE2 104 receives configure A1 event (Linked Freq: x Freq) for MLM HO from the cell1 110. At operation 223, the UE2 104 transmits A1 report (Linked Freq: x Freq) to the cell1 110. At operation 225, the cell3 114 is selected based on the weight based round robin algorithm and the weight of the cell3 114 is decremented by 1. Further, at operation 227, the weight of the cell3 114 is updated, as shown in Table 3:

TABLE 3

| Cells | Weight |
|---|---|
| Cell2 | 2 |
| Cell3 | 0 |

At operation 229, the cell1 110 transmits a HO request to the cell3 114. At operation 231, the UE2 104 performs handover with the cell3 114. At operation 233, the UE3 106 performs the attach process with the cell1 110. At operation 235, the UE3 106 receives configure A1 event (Linked Freq: x Freq) for MLM HO from the cell1 110. At operation 237, the UE3 106 transmits the A1 report (Linked Freq: x Freq) to the cell1 110. At operation 239, the cell2 112 is selected based on the weight based round robin algorithm and the weight of the cell2 112 is decremented by 1. Further, at operation 241, the weight of the cell2 112 is updated, as shown in Table 4:

TABLE 4

| Cells | Weight |
|---|---|
| Cell2 | 1 |
| Cell3 | 0 |

At operation 243, the cell1 110 transmits a HO request to the cell2 112. At operation 245, the UE3 106 performs handover with the cell2 112. At operation 247, the UE4 108 performs the attach process with the cell1 110. At operation 249, the UE4 108 receives configure A1 event (Linked Freq: x Freq) for MLM HO from the cell1 110. At operation 251, the UE4 108 transmits the A1 report (Linked Freq: x Freq) to the cell1 110. At operation 253, the cell2 112 is selected based on the weight based round robin algorithm and its weight is decremented by 1. Thus, the weight of both the cells, i.e., the cell 2 112 and the cell3 114 is 0. However, the blind HO list is reset to default configuration (also referred to as “config”) as the weight of all the cells is exhausted. Accordingly, at operation 255, the blind HO list is updated as below Table 5:

TABLE 5

| Cells | Weight |
|---|---|
| Cell2 | 3 |
| Cell3 | 1 |

At operation 257, the cell1 110 transmits a HO request to the cell2 112. At operation 245, the UE4 108 performs handover with the cell2 112. Further, it should be noted that the cell1 110, the cell2 112, and the cell3 114 are connected to one or more eNodeB (eNB)/gNode B (gNB) 116.

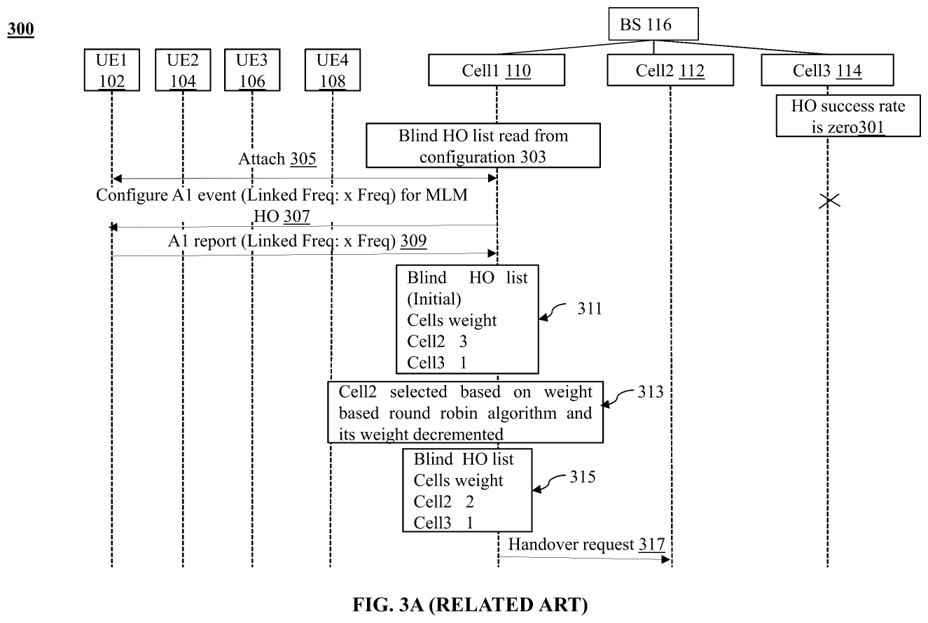

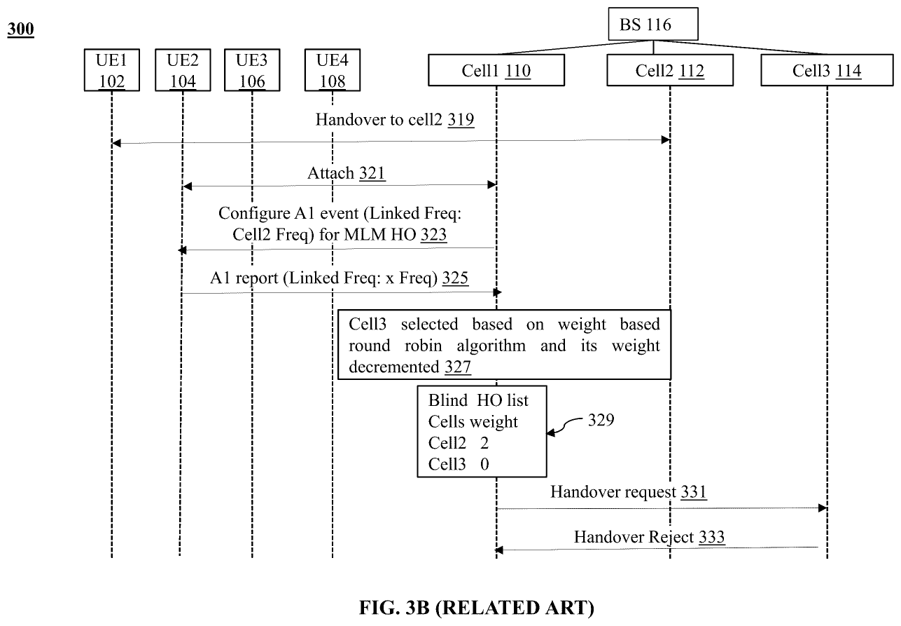

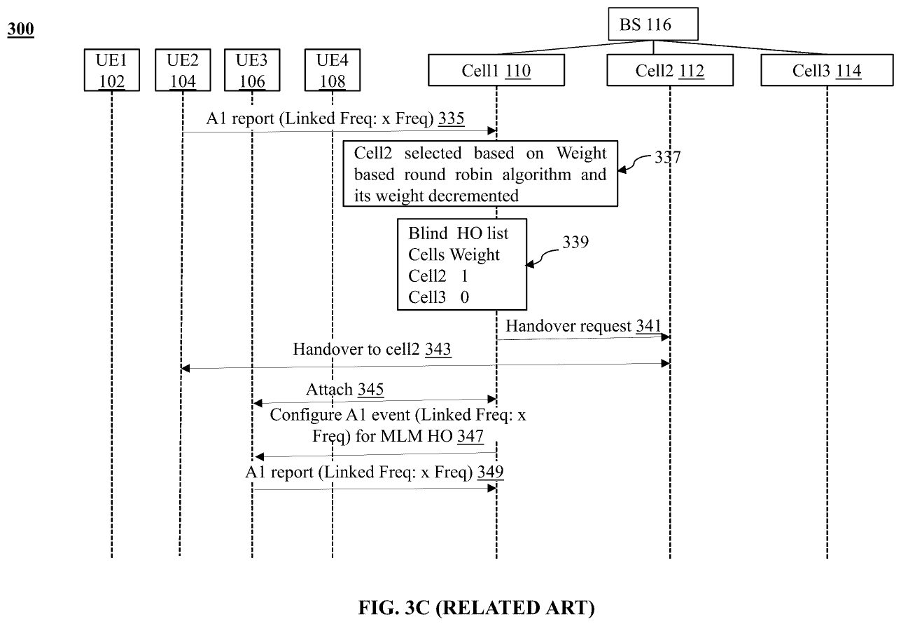

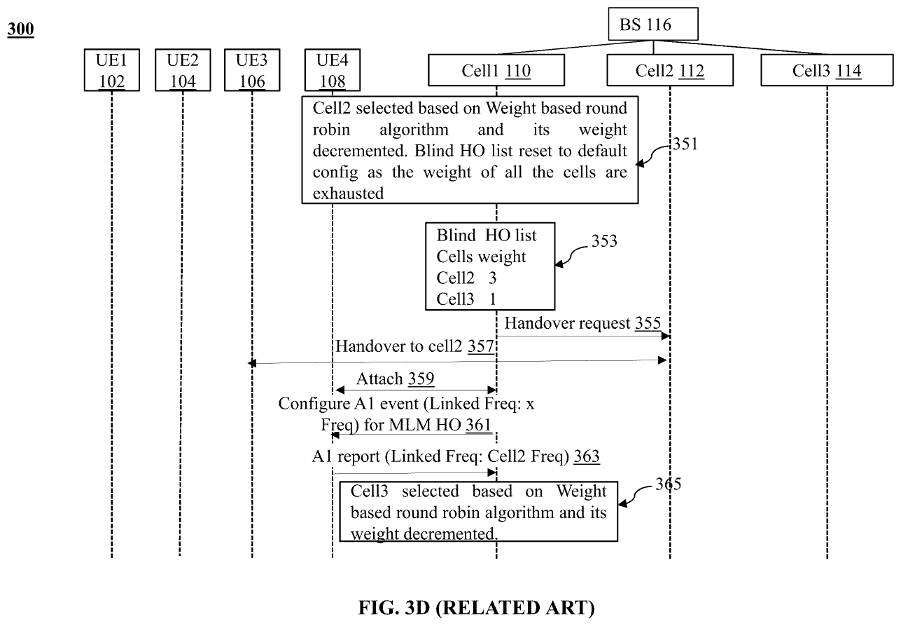

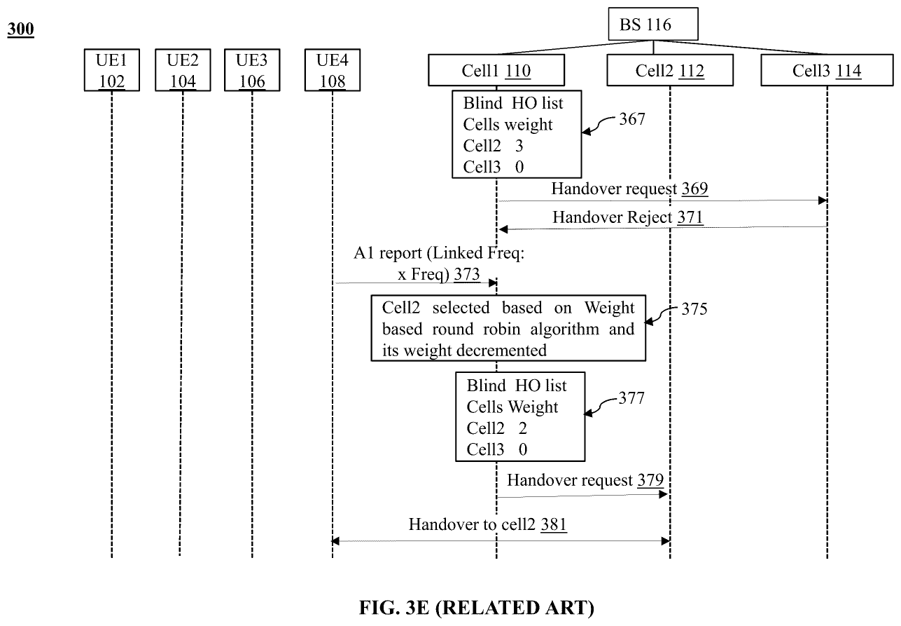

However, the HO process explained in reference to FIGS. 2A-2D does not consider the handover success rate of the cell. As a result, there is a risk that the HO to a cell may fail if that cell's success rate is poor. This type of HO failure is further illustrated with reference to FIGS. 3A-3E.

FIGS. 3A-3E illustrate signal flow diagrams 300 of failure of the HO process, according to related art. As shown, at operation 301, a HO success rate for the cell3 114 is zero indicating that the HO to the cell3 114 would fail. As can be noted, operations 303-329 are the same as operations 201-227 of FIGS. 2A-2B. Hence, the explanation of the same is not repeated for the sake of brevity of the disclosure. In continuation with explanation of the operation 227 of FIG. 2B (operation 329 of FIG. 3B), at operation 331, the cell1 110 transmits a HO request to the cell3 114. However, as the HO success rate of the cell3 114 is zero, at operation 333, the cell3 114 rejects the handover request. Accordingly, at operation 335, the UE2 104 again transmits the A1 report (Linked Freq: x Freq) to the cell1 110. At operation 337, the cell2 112 is selected based on the weight based round robin algorithm and the weight of the cell2 112 is decremented by 1. Further, at operation 339, the weight of the cell2 112 is updated, as shown in Table 6:

TABLE 6

| Cells | Weight |
|---|---|
| Cell2 | 1 |
| Cell3 | 0 |

At operation 341, the cell1 110 transmits a HO request to the cell2 112. At operation 343, the UE2 104 performs handover with the cell2 112. At operation 345, the UE3 106 performs the attach process with the cell1 110. At operation 347, the UE3 106 receives configure A1 event (Linked Freq: x Freq) for MLM HO from the cell1 110. At operation 349, the UE3 106 transmits the A1 report (Linked Freq: x Freq) to the cell1 110. At operation 351, the cell2 112 is selected based on the weight based round robin algorithm and the weight of the cell2 112 is decremented by 1. Thus, the weight of both the cells, i.e., the cell2 112 and the cell3 114 is 0. However, the blind HO list is reset to default config as the weight of all the cells is exhausted. Accordingly, at operation 353, the blind HO list is updated as below Table 7:

TABLE 7

| Cells | Weight |
|---|---|
| Cell2 | 3 |
| Cell3 | 1 |

At operation 355, the cell1 110 transmits a HO request to the cell2 112. At operation 357, the UE3 106 performs handover with the cell2 112. At operation 359, the UE4 108 performs the attach process with the cell1 110. At operation 361, the UE4 108 receives configure A1 event (Linked Freq: x Freq) for MLM HO from thee cell1 110. At operation 363, the UE4 108 transmits the A1 report (Linked Freq: x Freq) to the cell1 110. At operation 365, the cell3 114 is selected based on the weight based round robin algorithm. Further, at operation 367, the weight of the cell3 114 is decremented by 1, as shown in Table 8:

TABLE 8

| Cells | Weight |
|---|---|
| Cell2 | 3 |
| Cell3 | 0 |

At operation 369, the cell1 110 transmits a HO request to the cell3 114. However, as the HO success rate of the cell3 114 is zero, at operation 371, the cell3 114 rejects the handover request. Accordingly, at operation 373, the UE4 108 again transmits the A1 report (Linked Freq: x Freq) to the cell1 110. At operation 375, the cell2 112 is selected based on the weight based round robin algorithm and the weight of the cell2 112 is decremented by 1. Further, at operation 377, the weight of the cell2 112 is updated, as shown in Table 9:

TABLE 9

| Cells | Weight |
|---|---|
| Cell2 | 2 |
| Cell3 | 0 |

At operation 379, the cell1 110 transmits a HO request to the cell2 112. At operation 381, the UE4 108 performs handover with the cell2 112.

Thus, the existing techniques do not consider the handover success rate of the cells while performing the HO process.

Accordingly, the present disclosure provides techniques for rank based neighbor selection for MLM blind handover while considering the handover success rate of the cells.

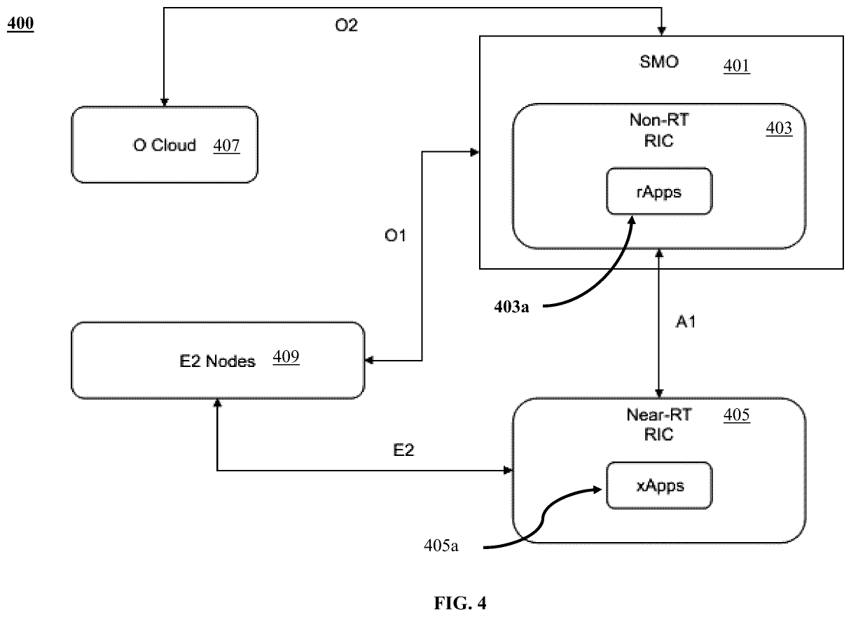

Referring now to the drawings, and more particularly to FIGS. 4 to 11, where similar reference characters denote corresponding features consistently throughout the figures, there are shown preferred embodiments.

FIG. 4 illustrates an Open Radio Access Network (O-RAN) architecture 400 including a near real time (RT) RAN intelligent controller (RIC) and a non-RT RIC, according to an embodiment of the present disclosure. The O-RAN Alliance, which is a global community of mobile network operators, vendors, and research and academic institutions focused on open RAN standards and interoperability, has defined a set of use cases and applications that the RIC supports. The RIC is divided into non-real-time and near-real-time components. The Non-Real Time RAN Intelligent Controller (Non-RT-RIC) 403 is an element of operator's centralized Service Management and Orchestration (SMO) 401 Framework, as defined by the O-RAN Alliance. On the other hand, the near-RT RIC 405 resides within a telco edge or regional cloud and generally enables network optimization actions that take between ten milliseconds to one second to complete.

The non-RT RIC 403 acts as a control point of a non-real-time control loop and operates on a timescale greater than 1 second within the SMO 401 framework. The functionalities of the non-RT RIC 403 may be implemented through applications called rApps 403a. The non-RT RIC may be connected to a near-RT RIC 405 over an A1 interface. The near-RT RIC 405 operates on a timescale between 10 milliseconds and 1 second. The functionalities of the near-RT RIC 405 may be implemented through applications called xApps 405a.

The near-RT RIC 405 may further be connected to E2 nodes (for instance, enB, gNB) over an E2 interface. The SMO framework 401 may manage and orchestrate various RAN elements. For instance, the SMO 401 may orchestrate an O-RAN Cloud (O-Cloud). The O-Cloud may refer to a collection of physical RAN nodes that host the RICs, O-Centralized Units (CUs), O-Distributed Units (DUs), etc., along with the supporting environments and components.

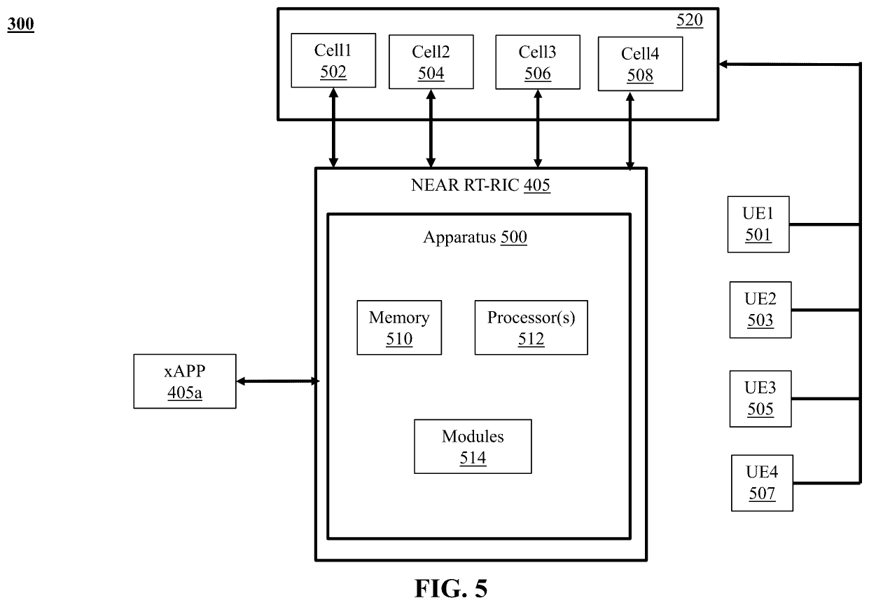

In an embodiment, the techniques of the present disclosure have been implemented in the near-RT RIC 405 and are further explained in reference to FIGS. 5-11.

FIG. 5 illustrates a schematic block diagram of the near-RT RIC 405 for a rank-based neighbor selection for an MLM blind handover, according to an embodiment of the present disclosure. The near-RT RIC 405 may include an apparatus 500 configured to perform operation of the near-RT RIC 405. Accordingly, the apparatus 500 may correspond to the near RT-RIC 400. In an embodiment, the apparatus 500 may be connected with the xApp 405a. In one embodiment, the apparatus 500 may be implemented within the near RT-RIC 405. It should be noted that the terms “RIC” and “near-RT RIC” have been used interchangeably throughout the description and drawings.

The apparatus 500 may be configured to receive a blind Handover (HO) list along with a plurality of parameters from a base station (BS) 520. The blind HO list may correspond to a plurality of neighboring cell associated with a serving cell in connection with the BS 520. For example, if the serving cell is 502, then the cells 504, 506, and 508 may be considered as the neighboring cells of the serving cell 502. Similarly, if the serving cell is 504, then the cells 502, 506, and 508 may be considered as neighboring cells of the serving cell 504 and so on. In an embodiment, the plurality of cells 502, 504, 506, and 508 are associated with the BS 520. It should be noted that each of the plurality of cells 502, 504, 506, and 508 may be associated with more than one BS. In another example, the plurality of cells 502, 504, 506, and 508 may be associated with different BS. The plurality of cells 502, 504, 506, and 508 may operate on different frequency bands. In another example, some of the plurality of cells 502, 504, 506, and 508 may operate on the same frequency bands. For example, the cell1 502 and the cell2 504 may operate on a high frequency band, such as B7 (2600), FDD, 20 MHz. The cell 3 506 may operate on a mid-frequency band, such as B2/B25 (1900), FDD, 15 MHz. The cell4 508 may operate on a low frequency band, such as B13 (700), FDD, 5 Mhz. Further, a plurality of UEs 501, 503, 505, and 507 may also be attached to one of the plurality of cells 502, 504, 506, and 508. The cell 502 has been considered as the serving cell for explanation purpose. Accordingly, the cells 504, 506, and 508 have been considered as the neighboring cells. In a non-limited embodiment, the blind HO list may include, but is not limited to identification information of the plurality of cells 502, 504, 506, and 508. The identification information may include but not limited to an Enhanced-Universal Mobile Telecommunications System Terrestrial RAN (E-UTRAN) Radio Access Network Cell Global Identifier (ECGI). In a non-limited embodiment, the plurality of parameters may be associated with each of the plurality of neighboring cells 504, 506, and 508. The plurality of parameters may include, but is not limited to an initial weight of each of the plurality of neighboring cells 504, 506, and 508, HO statistics of each of the plurality of neighboring cells 504, 506, and 508, a number of UEs (501, 503, 505, 507) attached to each of the plurality of neighboring cells 504, 506, and 508, physical resource block (PRB) utilization of each of the plurality of neighboring cells 504, 506, and 508, and a total data throughput of each of the plurality of neighboring cells 504, 506, and 508. In one non-limiting embodiment, the HO statistics may indicate the HO success rate of the corresponding cell. The apparatus 500 may be configured to compute a rank for each of the plurality of neighboring cells 504, 506, and 508 in the blind HO list based on the plurality of parameters of the corresponding cell. For example, if the HO success rate of a cell is 0 or if the number of UEs attached to the cell is equal to the maximum number of UEs allowed to attach to the cell or if the PRB utilization of the corresponding cell is full, then the apparatus 500 may compute the rank for that particular cell as 0. The apparatus 500 may then be configured to update the initial weight associated with each of the plurality of neighboring cells 504, 506, and 508 based on the corresponding computed rank. For example, if the rank of a particular cell is 0, then the apparatus 500 may update the corresponding initial weight as 0. The apparatus 500 may then be configured to update the blind HO list based on the updated weight associated with each of the plurality of neighboring cells 504, 506, and 508.

The apparatus 500 may include one or more processors (hereinafter referred to as the processor 512), a memory 510, and one or more modules 514. In one embodiment, the processor 512 may include at least one data processor for executing processes in a virtual storage area network. The processor 512 may include specialized processing units such as integrated system (bus) controllers, memory management control units, floating point units, graphics processing units, digital signal processing units, etc. In one embodiment, the processor 512 may include a central processing unit (CPU), a graphics processing unit (GPU), or both. The processor 512 may be one or more general processors, digital signal processors (DSPs), application-specific integrated circuits, field-programmable gate arrays (FPGAs), servers, networks, digital circuits, analog circuits, combinations thereof, or other now known or later developed devices for analyzing and processing data. The processor 512 may execute a software program, such as code generated manually (i.e., programmed) to perform the desired operation. The processor 512 may implement various techniques such as, but not limited to, image processing, data extraction, artificial intelligence (AI), machine learning (ML), deep learning (DL), and so forth to achieve the desired objective.

In one embodiment, the processor 512 may be configured to perform the functions of the apparatus 500.

The memory 510 may be communicatively coupled to the processor 512. The memory 510 may be configured to store data and instructions executable by the processor 512. In one embodiment, the memory 510 may communicate via a bus within the apparatus 500. The memory 510 may include but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 510 may include a cache or random-access memory for the processor 512. In alternative examples, the memory 510 is separate from the processor 512, such as a cache memory of a processor, the system memory, or other memory. The memory 510 may be an external storage device or database for storing data. The memory 510 may be operable to store instructions executable by the processor 512. The functions, acts, or tasks illustrated in the figures or described may be performed by the programmed processor 512 for executing the instructions stored in the memory 510. The functions, acts, or tasks are independent of the particular type of instructions set, storage media, processor, or processing strategy and may be performed by software, hardware, integrated circuits, firmware, micro-code, and the like, operating alone or in combination. Likewise, processing strategies may include multiprocessing, multitasking, parallel processing, and the like. The memory 510 may further include a database to store the data. Further, the memory 510 may include an operating system for performing one or more tasks of the apparatus 500, as performed by a generic operating system in the communications domain.

The modules 514, amongst other things, include routines, programs, objects, components, data structures, etc., which perform particular tasks or implement data types. The modules 514 may also be implemented as, signal processor(s), state machine(s), logic circuitries, and/or any other device or component that manipulates signals based on operational instructions. The modules 514 may be configured to one or more operations of the apparatus 500 and/or the processor 512.

Further, the modules 514 can be implemented in hardware, instructions executed by a processing unit, or by a combination thereof. The processing unit can comprise a computer, the processor 512, a state machine, a logic array, or any other suitable devices capable of processing instructions. The processing unit can be a general-purpose processor which executes instructions to cause the general-purpose processor to perform the required tasks, or the processing unit can be dedicated to performing the required functions. In another embodiment of the present disclosure, the modules 514 may be machine-readable instructions (software) which, when executed by a processor/processing unit, perform any of the described functionalities. Furthermore, the data serves, amongst other things, as a repository for storing data processed, received, and generated by one or more of the modules. The modules 514 may include a receiving module 602, a computing module 604, an updating module 606, and a transmitting module 608.

The apparatus 500 may also be connected to the xAPP 405a for storing the blind HO list and the plurality of parameters.

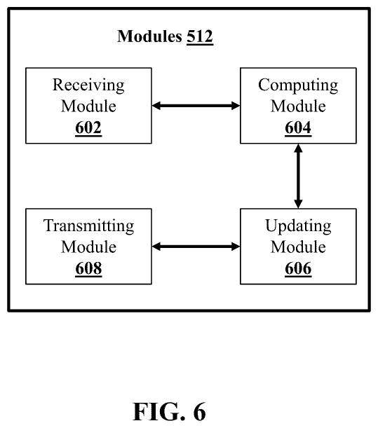

A detailed explanation of the various functions and the operations of the apparatus 500 and/or the associated processor 512 or the modules 514 has been explained in the following description with reference to FIGS. 6-9.

FIG. 6 illustrates a schematic operational flow diagram of the plurality of modules 514 of the apparatus 500 associated with the near-RT RIC 405, according to an embodiment of the present disclosure. The modules 514 may include a receiving module 602, a computing module 604, an updating module 606, and a transmitting module 608. The modules 514 may be coupled to the xAPP 405a.

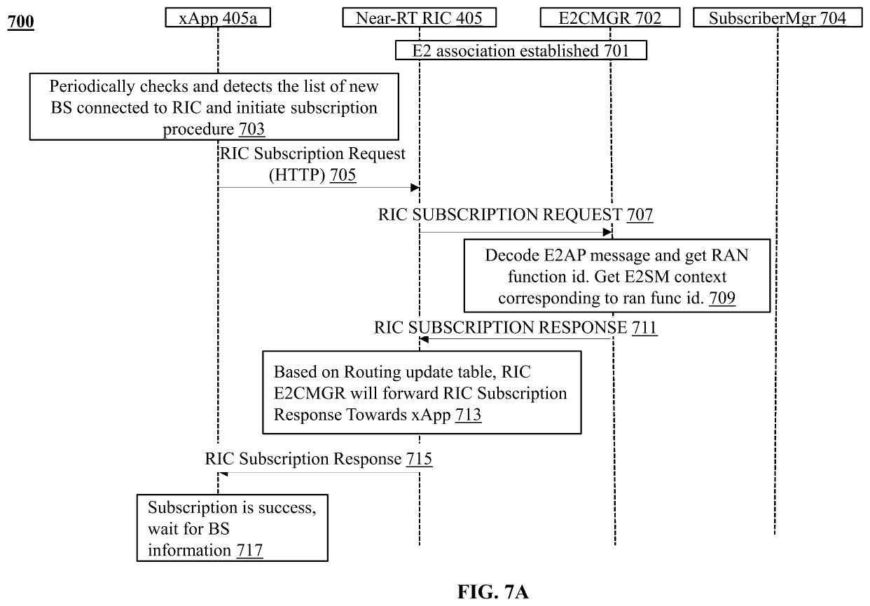

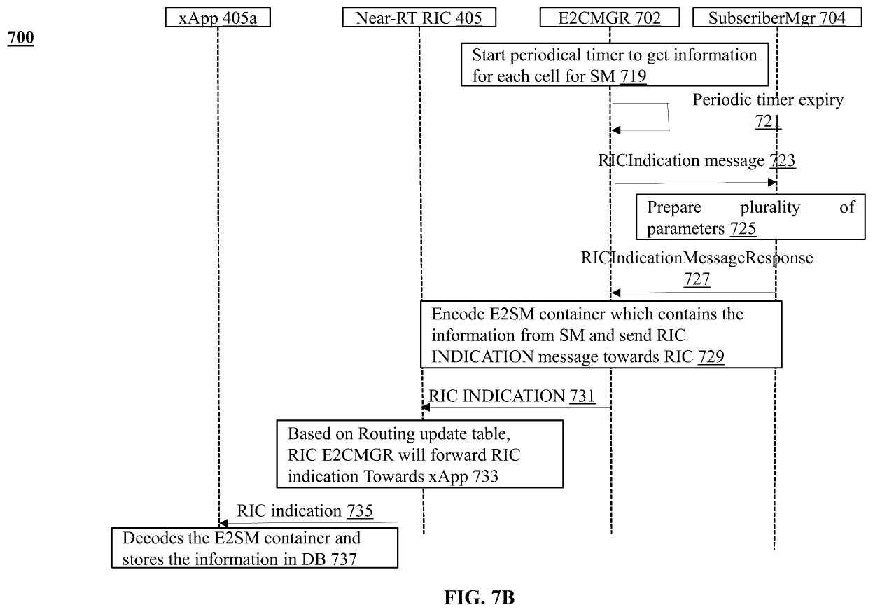

The receiving module 602 may be configured to receive the blind HO list along with a plurality of parameters from the base station (BS) 520. The blind HO list may be associated with the plurality of neighboring cells 504, 506, and 508. The plurality of neighboring cells 504, 506, and 508 may be associated with the BS 520. In another embodiment, the plurality of neighboring cells 504, 506, and 508 may be associated with different BS. In a non-limited embodiment, the blind HO list may include, but is not limited to identification information of the plurality of neighboring cells 504, 506, and 508. The identification information, may include but not limited to the ECGI. In a non-limited embodiment, the plurality of parameters may be associated with each of the plurality of neighboring cells 504, 506, and 508. The plurality of parameters may include, but is not limited to the initial weight associated with each of the plurality of neighboring cells 504, 506, and 508, the HO statistics, the number of UEs attached to each of the plurality of neighboring cells 504, 506, and 508, the PRB utilization of each of the plurality of neighboring cells 504, 506, and 508, and the total data throughput of each of the plurality of neighboring cells 504, 506, and 508. In one non-limiting embodiment, the HO statistics may indicate the HO success rate of the corresponding cell. In a non-limited embodiment, FIGS. 7A-7B illustrate signal flow diagrams 700 of reception of the blind HO list and the plurality of parameters, according to an embodiment of the present disclosure. In a non-limited embodiment, the cell 502 has been considered as the serving cell and the cells 504, 506, and 508 have been considered as the neighboring cells. However, it should be noted that any of the cells 502, 504, 506, and 508 may be the serving cell and accordingly, the neighboring cells will differ. As shown, at operation 701, an E2 association is established between the RIC 405 and an E2C manager (E2CMGR) 702. The E2CMGR 702 is a part of the BS 520. At operation 703, the xAPP 405a may periodically check and detect a list of new BSs connected to the RIC 405. Accordingly, the xAPP 405a may initiate a subscription procedure to receive the blind HO list and the plurality of parameters. Accordingly, at operation 705, the xApp 405a may transmit a RIC subscription request to the RIC 405. The xAPP 405a may transmit the RIC subscription request using a hypertext transfer protocol (HTTP). At operation 707, the RIC 405 may transmit the RIC subscription request to receive the blind HO list and the plurality of parameters to the E2CMGR 702. At operation 709, the E2CMGR 702 may decode E2 application protocol (AP) message and get RAN function identification (ID) and E2SM context corresponding to the RAN function ID. The RAN function ID may help in identifying the RIC 405. At operation 711, the E2CMGR 702 may transmit a RIC subscription response to the RIC 405 in response to the RIC subscription request. At operation 713, the RIC 405 may decide to transmit the RIC subscription response to the xAPP 405a based on a routing update table. The routing update table may help in identifying the xAPP 405a. Accordingly, at operation 715, the RIC 405 may transmit the RIC subscription response to the xAPP 450a. At 717, the subscription is successful and the xAPP 405a waits for information associated with the BS. At operation 719, a predefined periodic timer is started at the E2CMGR 702 to get information for each cell associated with the BS from a subscriber manager (SM) 704. In a non-limited embodiment, the E2CMGR 702 may start the predefined timer to get information for the plurality of neighboring cells 504, 506, and 508. The information may include the plurality of parameters for the plurality of neighboring cells 504, 506, and 508. The SM 704 may also be associated with the BS 520. Further, it should be noted that the predefined periodic timer may be preconfigured or user defined. Further, the predefined periodic timer may be set to intervals of seconds, minutes, hours, or days. At operation 721, the predefined periodic timer is expired. Accordingly, at operation 723, the E2CMGR 702 may transmit a RICIndicationMessage requesting the information associated with the plurality of neighboring cells 504, 506, and 508, to the SM 704. Then, at operation 725, the SM 704 may prepare a RIC indication response consisting the plurality of parameters for the plurality of neighboring cells 504, 506, and 508. At operation 727, the SM 704 may transmit the plurality of parameters in an RICIndicationMessageResponse to the E2CMGR 702 . . . . At operation 729, the E2CMGR 702 may encode an E2SM container which contains the information received from the SM 704 and send RIC indication towards the RIC 405. Accordingly, at operation 731, the RIC 405 may receive the plurality of parameters from the E2CMGR 702 in the RIC indication response. Accordingly, the RIC 405 may receive the plurality of parameters after the expiry of the predefined periodic timer. At operation 733, the RIC 405 may decide to transmit the RIC indication response to the xAPP 405a based on the routing update table. Accordingly, at operation 735, the RIC 405 may transmit the RIC indication to the xAPP 405a. At operation 737, the xAPP 405a may decode the E2SM container received in the RIC indication and store the information in a database (DB).

The computing module 604 may be configured to compute the rank for each of the plurality of neighboring cells 504, 506, and 508 based on the plurality of parameters. For example, if the HO success rate of the cell is 0 or if the number of UEs attached to the cell is equal to the maximum number of UEs allowed to attach to the cell or if the PRB utilization of the cell is full, then the apparatus 500 may compute the rank for that particular cell as 0.

The updating module 606 may be configured to update the initial weight associated with each of the plurality of neighboring cells 504, 506, and 508 based on the corresponding computed rank. For example, if the rank of a particular cell is 0, then the updating module 606 may update the corresponding initial weight as 0. The updating module 606 may also be configured to update the blind HO list based on the updated weight associated with each of the plurality of neighboring cells 504, 506, and 508. For example, Table 10 shows the initial weight and the updated weight of the plurality of neighboring cells of the cell 502 in the blind HO list:

TABLE 10

| Cells | Initial Weight | Updated Weight |
|---|---|---|
| Cell504 | 3 | 3 |
| Cell506 | 2 | 2 |
| Cell508 | 2 | 0 |

In a further example, it is possible that the HO rate of any of the neighboring cells 504, 506, and 508 is not poor. Accordingly, Table 11 shows the initial weight and the updated weight of the plurality of neighboring cells 504, 506, and 508 of the blind HO list:

TABLE 11

| Cells | Initial Weight | Updated Weight |
|---|---|---|
| Cell504 | 3 | 6 |
| Cell506 | 5 | 3 |
| Cell508 | 6 | 5 |

Further, the transmitting module 608 may be configured to transmit the updated blind HO list to the BS 520 to perform the HO.

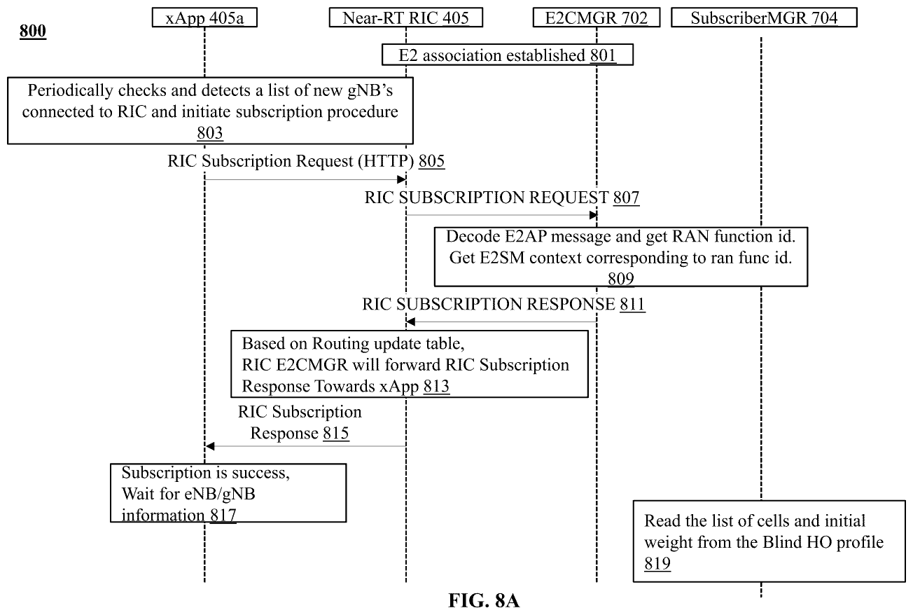

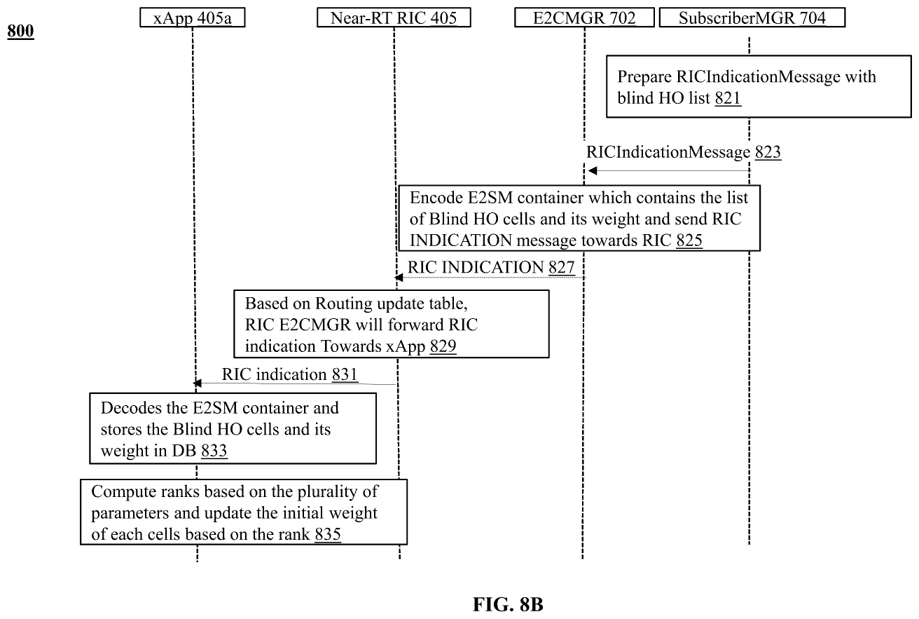

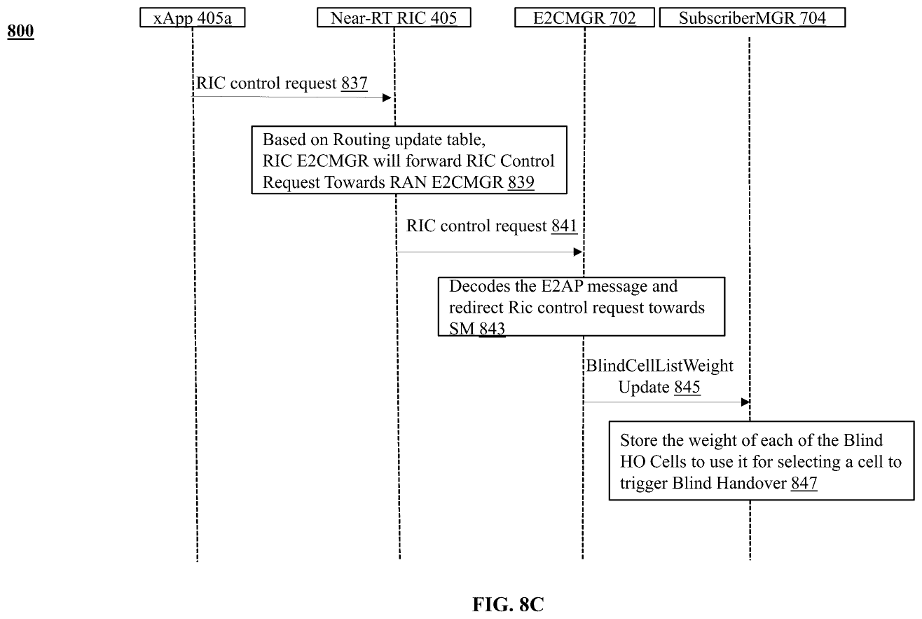

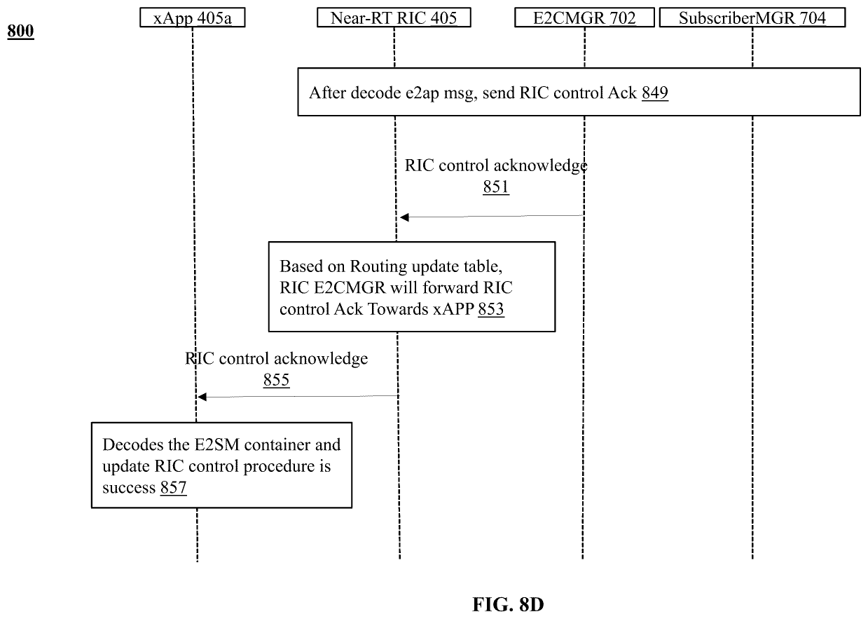

A detailed explanation of the modules 604, 606, and 608 is further provided in reference to FIGS. 8A-8D.

In a non-limited embodiment, FIGS. 8A-8D illustrate signal flow diagrams of updating and transmitting the blind HO list, according to an embodiment of the present disclosure. As can be noticed, operations 801-817 are similar to the operations 701-717 of FIG. 7A. Hence, the explanation of the same is not repeated for the sake of brevity of the present disclosure. In continuation with operation 817 (operation 717 of FIG. 7A), at operation 819, the SM 704 may read the list of the plurality of neighboring cells 504, 506, and 508 and the corresponding initial weights from a Blind HO profile of the cells. The SM 704 may read the said list from an eNB/gNB configuration file corresponding to the eNB/gNB associated with the SM 704. At operation 821, the SM 704 may prepare the RICIndicationMessage with the blind HO list. At operation 823, the SM 704 may transmit the RICIndicationMessage to the E2CMGR 702. At operation 825, the E2CMGR 702 may encode an E2SM container which contains the blind HO list and the plurality of parameters to send an RIC indication response to the RIC 405. Accordingly, at operation 827, the RIC 405 may receive the plurality of parameters from the E2CMGR 702 in the RIC indication response. At operation 829, the RIC 405 may decide to transmit the RIC indication response to the xAPP 405a based on the routing update table. Accordingly, at operation 831, the RIC 405 may transmit the RIC indication to the xAPP 405a. At operation 833, the xAPP 405a may decode the E2SM container received in the RIC indication and store the information in the database (DB). At operation 835, the xAPP 405a may compute the rank for each of the plurality of neighboring cells 504, 506, and 508 based on the plurality of parameters. The xAPP 405a may also update the initial weight of each of the plurality of neighboring cells 504, 506, and 508 based on the corresponding computed rank. The xAPP 405a may also update the blind HO list based on the updated weights. In a further embodiment, if the weights associated with each of the plurality of neighboring cells 504, 506, and 508 are zero, then the RIC 405 may again receive the blind HO list. Then, the RIC 405 may also update the blind HO list as discussed above. Then, at operation 837, the xAPP 405a may transmit the updated blind HO list to the RIC 405 in an RIC control request. At operation 839, the RIC 405 may decide to forward the RIC control request to the E2CMGR 702 based on the routing update table. Accordingly, at operation 841, the RIC 405 may transmit the RIC control request containing the updated blind HO list to the E2CMGR 702. At operation 843, the E2CMGR 702 may decode the E2AP message and redirect the RIC control request towards SM 704. At operation 845, the E2CMGR 702 may transmit the updated blind HO list with updated weights to the SM 704. At operation 847, the SM 704 may store the updated weight of each of the plurality of neighboring cells 504, 506, and 508 to use it for selecting a cell to trigger blind HO. At operation 849, the E2CMGR 702 may after decoding E2APP msg, send RIC control ack. At operation 851, the E2CMGR 702 may transmit the RIC control acknowledge message to the RIC 405. At operation 853, the RIC 405 may decide to forward the RIC control acknowledge message to the xAPP 405a based on the routing update table. Accordingly, at operation 855, the RIC 405 may transmit the RIC control ack message to the xAPP 405a. At operation 857, the RIC 405 may decode the E2SM container and update that the RIC control procedure is successful. It should be noted that, although the functions of the modules 604 and 606 are shown to be performed by xAPP 405a, the RIC 405 may also perform the functions of the modules 604 and 606, if xAPP 405a is not part of RIC 405.

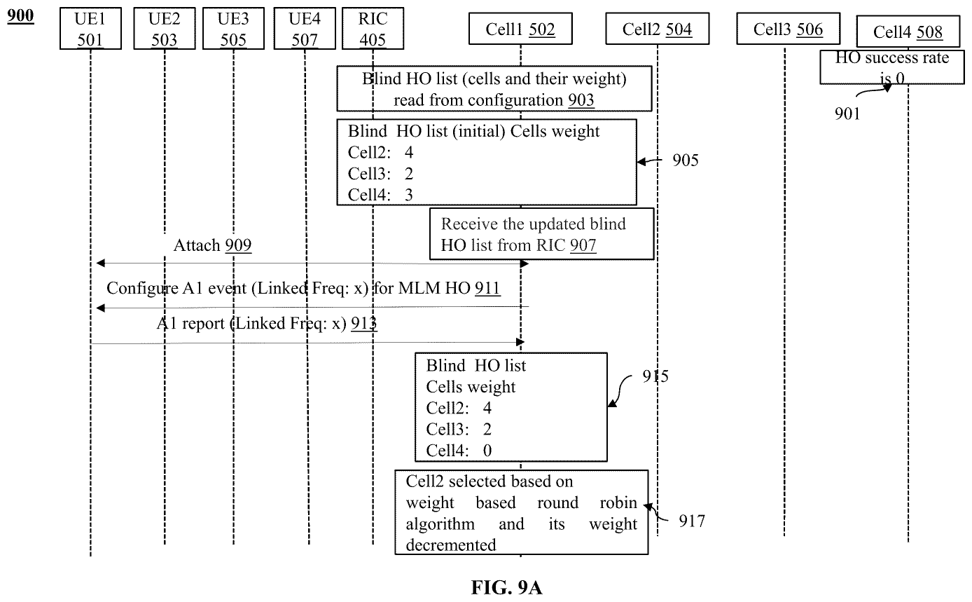

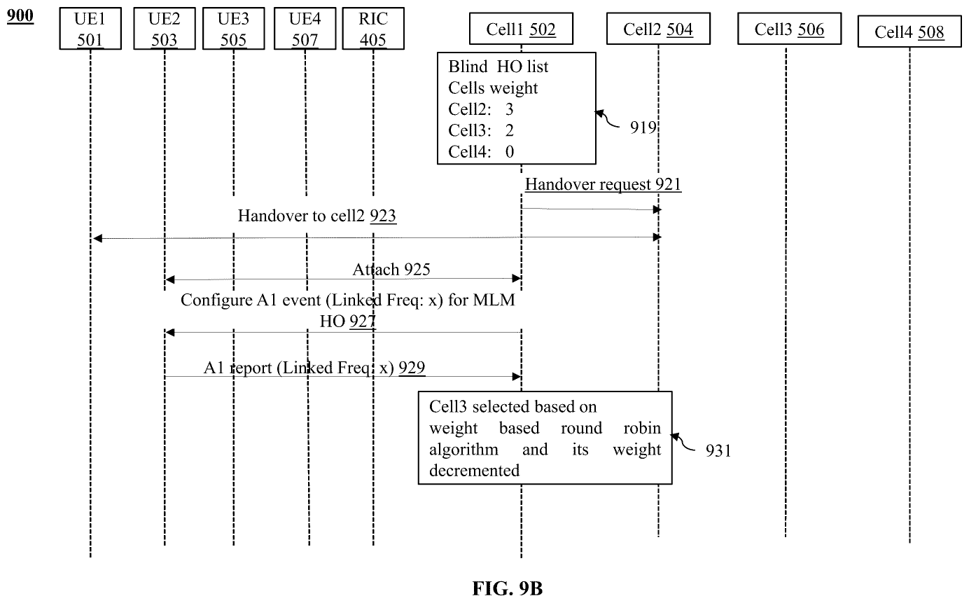

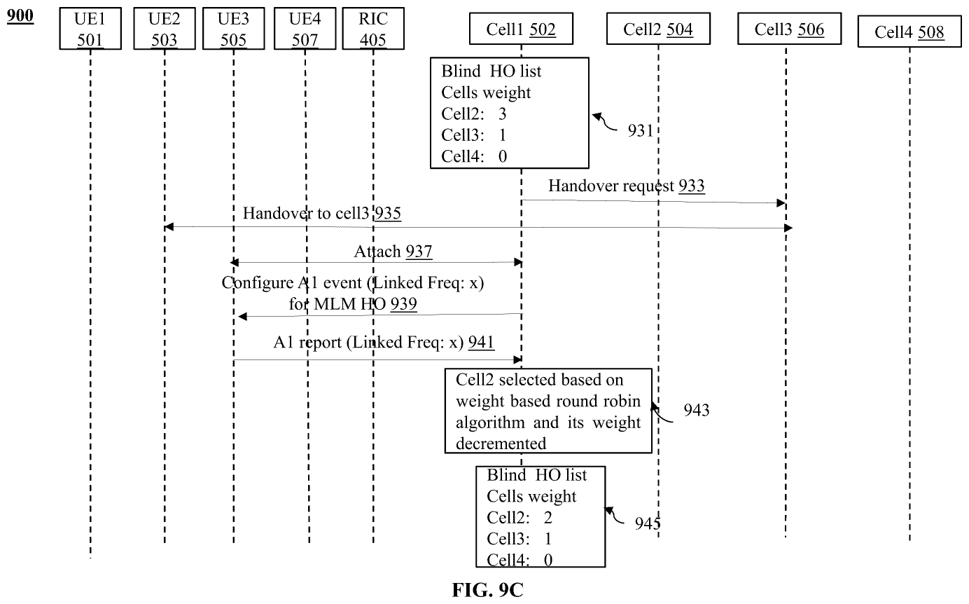

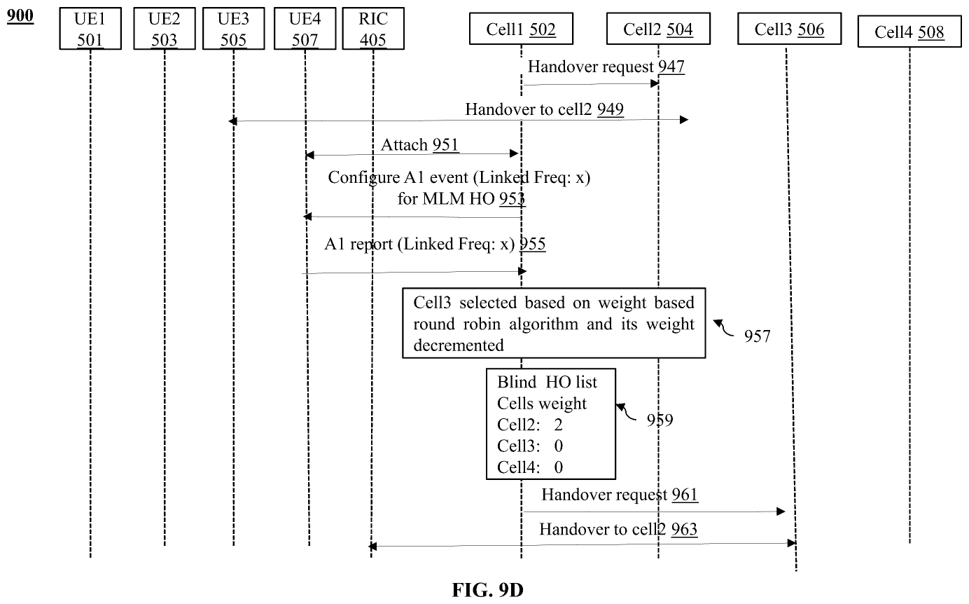

FIGS. 9A-9D illustrate signal flow diagrams 900 of the HO process, according to an embodiment of the present disclosure. cell2 504, Cell3 506 and Cell4 508 may operate on the same frequency (x). As shown, at operation 901, the HO success rate of the cell4 508 is 0. At operation 903, the cell1 502 reads the Blind HO list read from configuration. The cell1 502 may read the Blind HO list from an eNB/gNB configuration file corresponding to the eNB/gNB associated with the cell1 502. At operation 905, the cell1 502 may may refer to the blind HO list, as shown in Table 12:

TABLE 12

| Cells | Weight |
|---|---|
| Cell2 | 4 |
| Cell3 | 2 |
| Cell4 | 3 |

At operation 907, the cell1 502 receives an updated blind HO list from the RIC 405. As the HO success rate of the cell4 508 is 0, the corresponding weight in the updated blind HO list is also 0. At operation 909, the UE1 501 performs an attach process with the cell1 502. At operation 911, the UE1 501 receives configure A1 event (Linked Freq: x) for MLM HO from the cell1 502. At operation 913, the UE1 501 transmits an A1 report (Linked Freq: x) to the cell1 502. At operation 915, the cell1 502 may refer to the blind HO list, as shown in Table 13:

TABLE 13

| Cells | Weight |
|---|---|
| Cell2 | 4 |
| Cell3 | 2 |
| Cell4 | 0 |

At operation 917, the cell2 504 is selected based on a weight based round robin algorithm and the weight of the cell2 504 is decremented by 1. Further, at operation 919, the weight of the cell2 504 is updated as shown in Table 14:

TABLE 14

| Cells | Weight |
|---|---|
| Cell2 | 3 |
| Cell3 | 2 |
| Cell4 | 0 |

At operation 921, the cell1 502 transmits a HO request to the cell2 504. At operation 923, the UE1 501 performs handover with the cell2 504. At operation 925, the UE2 503 performs the attach process with the cell1 502. At operation 927, the UE2 503 receives configure A1 event (Linked Freq: x) for MLM HO from the cell1 502. At operation 929, the UE2 503 transmits the A1 report (Linked Freq: x) to the cell1 502. At operation 931, the cell3 506 is selected based on the weight based round robin algorithm and the weight of the cell3 506 is decremented by 1. Further, at operation 933, the weight of the cell3 506 is updated as shown in Table 15:

TABLE 15

| Cells | Weight |
|---|---|
| Cell2 | 3 |
| Cell3 | 1 |
| Cell1 | 0 |

At operation 935, the cell1 502 transmits a HO request to the cell3 506. At operation 937, the UE2 503 performs handover with the cell3 506. At operation 939, the UE3 505 performs the attach process with the cell1 502. At operation 941 the UE3 505 receives configure A1 event (Linked Freq: x) for MLM HO from the cell1 502. At operation 943, the UE3 505 transmits the A1 report (Linked Freq: x) to the cell1 502. At operation 945 the cell2 504 is selected based on the weight based round robin algorithm and the weight of the cell2 504 is decremented by 1. Further, at operation 947, the weight of the cell2 504 is updated as shown in Table 16:

TABLE 16

| Cells | Weight |
|---|---|
| Cell2 | 2 |
| Cell3 | 1 |
| Cell4 | 0 |

At operation 949, the cell1 502 transmits a HO request to the cell2 504. At operation 951, the UE3 505 performs handover with the cell2 504. At operation 953, the UE4 507 performs the attach process with the cell1 502. At operation 955, the UE4 507 receives configure A1 event (Linked Freq: x) for MLM HO from the cell1 502. At operation 957, the UE4 507 transmits the A1 report (Linked Freq: x) to the cell1 502. At operation 959, the cell3 506 is selected based on the weight based round robin algorithm and the weight of the cell3 506 is decremented by 1. Further, at operation 961, the weight of the cell3 506 is updated, as shown in Table 17:

TABLE 17

| Cells | Weight |
|---|---|
| Cell2 | 2 |
| Cell3 | 0 |
| Cell1 | 0 |

At operation 961, the cell1 502 transmits a HO request to the cell3 506. At operation 963, the UE4 507 performs handover with the cell3 506.

Accordingly, the HO process explained in reference to FIGS. 9A-9D considers the handover success rate of the cell. For example, as the HO success rate of the cell4 508 is 0, the cell4 508 is not considered for HO. As a result, the risk of failure of the HO to the cell is mitigated.

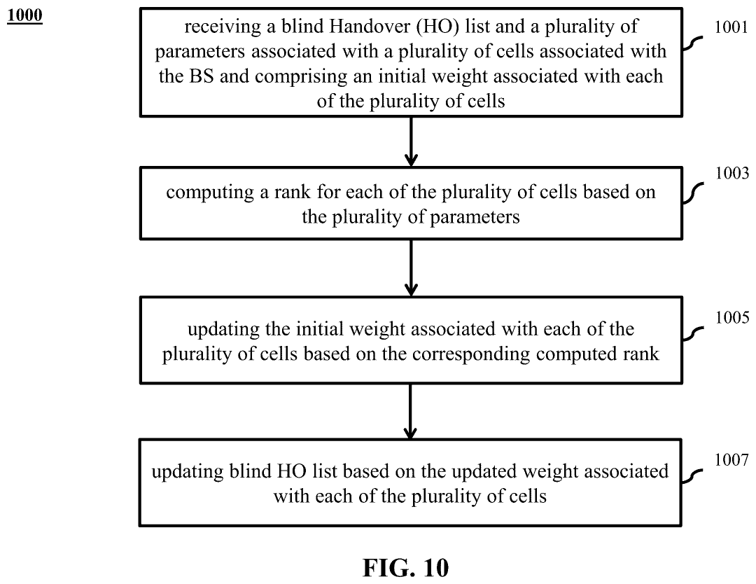

FIG. 10 illustrates a flowchart depicting a method 1000 for the rank-based neighbor selection to perform the MLM blind handover, according to an embodiment of the present disclosure. The method 1000 may be performed by the apparatus 500.

At step 1001, the method 100 may include receiving, by the RIC 405, from the BS 520, the blind HO list along with a plurality of parameters associated with the plurality of neighboring cells 504, 506, and 508. The plurality of neighboring cells 504, 506, and 508 are associated with the BS 520. In another embodiment, the plurality of neighboring cells 504, 506, and 508 may be associated with different BS. The plurality of parameters may include, but is not limited to the initial weight associated with each of the plurality of neighboring cells 504, 506, and 508, HO statistics associated with each of the plurality of neighboring cells 504, 506, and 508, the number of UEs attached to the cell, the PRB utilization of each of the plurality of neighboring cells 504, 506, and 508, and the total data throughput of the cell. The method 1000 may include receiving the blind HO list and initial weight of the plurality of the neighboring cells initially and every time the weights of the neighboring cells in the Blind HO list is exhausted, and the plurality of parameters of the plurality of the neighboring cells after an expiry of the predefined periodic timer at the BS 520. The method 1000 may also include receiving the plurality of parameters in the RIC indication response.

At step 1003, the method 1000 may include computing, by the RIC 405, the rank for each of the plurality of neighboring cells 504, 506, and 508 in the blind HO list based on the plurality of parameters.

At step 1005, the method 1000 may include updating, by the RIC 405, the initial weight associated with each of the plurality of neighboring cells 504, 506, and 508 in the blind HO list based on the corresponding computed rank. At step 1007, the method 1000 may include updating, by the RIC 405, the blind HO list based on the updated weight associated with each of the plurality of neighboring cells 504, 506, and 508.

While the above-discussed steps in FIG. 10 are shown and described in a particular sequence, the steps may occur in variations to the sequence in accordance with various embodiments. Further, a detailed description related to the various steps of FIG. 10 is already covered in the description related to FIGS. 4-9B and is omitted herein for the sake of brevity.

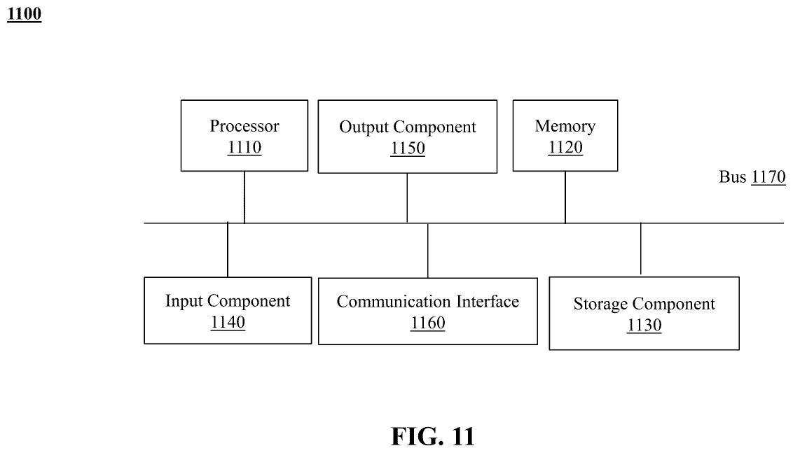

FIG. 11 is a diagram of example components of a wireless communication device 1100 (also referred to as the device/apparatus 1100), according to an embodiment of the present disclosure. In one or more embodiments, the wireless communication device 1100 may correspond to a wireless server and/or the apparatus 500. As shown in FIG. 11, the device 1100 includes a processor 1110, a memory 1120, a storage component 1130, an input component 1140, an output component 1150, a communication interface 1160, and a bus 1170.

The processor 1110, as used herein, means any type of computational circuit that may comprise hardware elements and software elements. The processor 1110 may be embodied as a multi-core processor, a single-core processor, or a combination of one or more multi-core processors and/or one or more single-core processors, a distributed processing system, or the like. The processor 1110 may be a Central Processing Unit (CPU), a Graphics Processing Unit (GPU), an Accelerated Processing Unit (APU), an Application-Specific Integrated Circuit (ASIC), or another type of processing component.

The memory 1120 includes a non-transitory computer-readable medium. The memory 1120 includes a Random-Access Memory (RAM), a Read Only Memory (ROM), and/or another type of dynamic or static storage device (e.g., a flash memory, a magnetic memory, and/or an optical memory) that stores information and/or instructions for use by the processor 1110. The memory 1120 comprises machine-readable instructions which are executable by the processor 1110. These machine-readable instructions when executed by the processor 1110 cause the processor 1110 to perform one or more method steps of an embodiment described above.

The storage component 1130 stores information and/or software related to the operation and use of the device 1100. For example, the storage component 1130 may include a hard disk (e.g., a magnetic disk, an optical disk, a magneto-optic disk, and/or a solid-state disk), a Compact Disc (CD), a Digital Versatile Disc (DVD), a floppy disk, a cartridge, a magnetic tape, and/or another type of non-transitory computer-readable medium, along with a corresponding drive.

The input component 1140 is configured to receive information, such as user input. For example, the input component 1140 may include, but not be limited to, a touch screen display, a keyboard, a keypad, a mouse, a button, a switch, and/or a microphone. Additionally, or alternatively, the input component 1140 may include a sensor for sensing information (e.g., a Global Positioning System (GPS), an accelerometer, a gyroscope, and/or an actuator).

The output component 1150 is configured to provide output information from the device 1100. For example, the output component 1150 may include, but is not limited to, a display, a speaker, an instruction device to an external device, and/or one or more Light-Emitting Diodes (LEDs).

The communication interface 1160 is an interface that provides a communication connection to other devices, such as external devices and internal devices. The connection by the communication interface 1160 can be a wired connection, a wireless connection, or a combination of wired and wireless connections, and can be a direct connection or an indirect connection via a communication network that exists between the device 1100 and other devices. In other words, the standard of the communication interface 1160 is not limited.

The bus 1170 acts as an interconnect between the processor 1110, the memory 1120, the storage component 1130, the input component 1140, the output component 1150, and the communication interface 1160 of the device 1100. The bus 1170 may include a wired interconnection or a wireless interconnection.

The number and arrangement of components shown in FIG. 11 are provided as an example. In practice, the device 1100 may include additional components, fewer components, different components, or differently arranged components than those shown in FIG. 11. Additionally, or alternatively, a set of components (e.g., one or more components) of the device 1100 may perform one or more functions described as being performed by another set of components of the device 1100. Further, one or more method steps described in any of the embodiments may be performed utilizing a plurality of devices 1100 in communication with one another.

It is understood that terms including “unit” or “module” at the end may refer to the unit for processing at least one function or operation and may be implemented in hardware, software, or a combination of hardware and software.

In one embodiment, a method is described. The method includes receiving, by a Radio Access Network (RAN) Intelligent Controller (RIC) from a Base station (BS), a blind Handover (HO) list and a plurality of parameters corresponding to a plurality of neighboring cells associated with a serving cell in connection with the BS, wherein the plurality of parameters comprises an initial weight associated with each of the plurality of neighboring cells. Further, the method includes computing, by the RIC, a rank for each of the plurality of neighboring cells in the blind HO list based on the plurality of parameters. The method further includes updating, by the RIC, the initial weight associated with each of the plurality of neighboring cells in the blind HO list based on the corresponding computed rank. The method also includes updating, by the RIC, the blind HO list based on the updated weight associated with each of the plurality of neighboring cells.

The method as described in [0071], the method comprises:
transmitting, by the RIC to the BS, the updated blind HO list to perform a HO.

The method as described in any one of [0071]-[0072], wherein prior to receiving the blind HO list and the plurality of parameters, the method comprises:
transmitting, by the RIC to the BS, a subscription request to receive the blind HO list and the plurality of parameters.

The method as described in any one of [0071]-[0073], wherein receiving the plurality of parameters comprises:
receiving, by the RIC from the BS, the plurality of parameters after an expiry of a predefined periodic timer at the BS

The method as described in any one of [0071]-[0074], wherein receiving the blind HO list comprises:
receiving, by the RIC from the BS, the blind HO list when the updated weight associated with each of the plurality of neighboring cells is zero.

The method as described in any one of [0071]-[0075], wherein receiving the plurality of parameters comprises:
receiving, by the RIC from the BS, the plurality of parameters in a RIC indication response.

The method as described in any one of [0071]-[0076], wherein transmitting the updated blind HO list to perform the HO comprises:
transmitting, by the RIC to the BS, the updated blind HO list to perform the HO in a RIC control request.

The method as described in any one of [0071]-[0077], wherein the plurality of parameters further comprises at least one of HO statistics, a number of User Equipment (UEs) attached to the cell, Physical Resource Block (PRB) utilization, and a total data throughput of the cell.

In another embodiment, an apparatus is described. The apparatus is configured to receive, from a Base Station (BS), a blind Handover (HO) list and a plurality of parameters corresponding to a plurality of neighboring cells associated with a serving cell in connection the BS, wherein the plurality of parameters comprises an initial weight associated with each of the plurality of neighboring cells in the blind HO list. The apparatus is further configured to compute a rank for each of the plurality of neighboring cells in the blind HO list based on the plurality of parameters. The apparatus is also configured to update the initial weight associated with each of the plurality of neighboring cells in the blind HO list based on the corresponding computed rank. The apparatus is further configured to update the blind HO list based on the updated weight associated with each of the plurality of neighboring cells.

The apparatus as described in [0079], wherein the apparatus is further configured to transmit, to the BS, the updated blind HO list to perform a HO.

The apparatus as described in any one of [0079]-[0080], wherein prior to receiving the blind HO list and the plurality of parameters, the apparatus is configured to:
transmit, to the BS, a subscription request to receive the blind HO list and the plurality of parameters.

The apparatus as described in any one of [0079]-[0081], wherein the apparatus is configured to receive, from the BS, the plurality of parameters after an expiry of a predefined periodic timer at the BS.

The apparatus as described in any one of [0079]-[0082], wherein the apparatus is configured to receive, from the BS, the plurality of parameters in a RIC indication response.

The apparatus as described in any one of [0079]-[0083], wherein the apparatus is configured to receive, from the BS, the blind HO list when the updated weight associated with each of the of the plurality of neighboring cells is zero.

The apparatus as described in any one of [0079]-[0084], wherein the apparatus is further configured to transmit, to the BS, the updated blind HO list to perform the HO in a RIC control request.

The apparatus as described in any one of [0079]-[0085], wherein the plurality of parameters further comprises at least one of HO statistics, a number of User Equipment (UEs) attached to the cell, Physical Resource Block (PRB) utilization, and a total data throughput of the cell.

The apparatus as described in any one of [0079]-[0086], wherein the apparatus corresponds to a Radio Access Network (RAN) Intelligent Controller (RIC).

In one embodiment, a non-transitory computer-readable medium storing instructions is described. The non-transitory computer-readable medium storing instructions, the instructions comprising: one or more instructions that, when executed by a RIC, the RIC comprising one or more processors, cause the one or more processors to receive, from a Base Station (BS), a blind Handover (HO) list and a plurality of parameters corresponding to a plurality of neighboring cells associated with a serving cell in connection with the BS, wherein the plurality of parameters comprises an initial weight associated with each of the plurality of neighboring cells in the blind HO list. The one or more instructions further cause the one or more processor compute a rank for each of the plurality of neighboring cells in the blind HO list based on the plurality of parameters. The one or more instructions further cause the one or more processor to update the initial weight associated with each of the plurality of neighboring cells in the blind HO list based on the corresponding computed rank. The one or more instructions further cause the one or more processor to update the blind HO list based on the updated weight associated with each of the plurality of neighboring cells.

The non-transitory computer-readable medium as described in [0087], wherein the instructions cause the one or more processor to:
transmit, to the BS, the updated blind HO list to perform a HO.

The non-transitory computer-readable medium as described in any one of [0087]-[0088], wherein the plurality of parameters further comprises at least one of HO statistics, a number of User Equipment (UEs) attached to the cell, Physical Resource Block (PRB) utilization, and a total data throughput of the cell.

Accordingly, the present disclosure provides techniques for rank based neighbor selection for MLM blind handover.

Embodiments of the present disclosure offer several significant commercial and technical advantages, for example:

Minimizing the HO failure: minimizing the HO failure by considering the HO success rate of a cell.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. A method, comprising:
receiving, by a Radio Access Network (RAN) Intelligent Controller (RIC) from a Base station (BS), a blind Handover (HO) list and a plurality of parameters corresponding to a plurality of neighboring cells associated with a serving cell in connection with the BS, wherein the plurality of parameters comprises an initial weight of each of the neighboring cells in the blind HO list;
computing, by the RIC, a rank for each of the neighboring cells in the blind HO list based on the plurality of parameters;
updating, by the RIC, the initial weight of each of the neighboring cells in the blind HO list based on the corresponding computed rank; and
updating, by the RIC, the blind HO list based on the updated weight associated with each of the plurality of neighboring cells.

2. The method as claimed in claim 1, further comprising:
transmitting, by the RIC to the BS, the updated blind HO list to perform a HO.

3. The method as claimed in claim 1, wherein prior to receiving the blind HO list and the plurality of parameters, the method comprises:
transmitting, by the RIC to the BS, a subscription request to receive the blind HO list and the plurality of parameters.

4. The method as claimed in claim 1, wherein receiving the plurality of parameters comprises:
receiving, by the RIC from the BS, the plurality of parameters after an expiry of a predefined periodic timer at the BS.

5. The method as claimed in claim 1, wherein receiving the blind HO list comprises:
receiving, by the RIC from the BS, the blind HO list when the updated weight associated with each of the plurality of cells is zero.

6. The method as claimed in claim 1, wherein receiving the plurality of parameters comprises:
receiving, by the RIC from the BS, the plurality of parameters in a RIC indication response.

7. The method as claimed in claim 2, wherein transmitting the updated blind HO list to perform the HO comprises:
transmitting, by the RIC to the BS, the updated blind HO list to perform the HO in a RIC control request.

8. The method as claimed in claim 1, wherein the plurality of parameters further comprises at least one of HO statistics, a number of User Equipment (UEs) attached to the cell, Physical Resource Block (PRB) utilization, and a total data throughput of the cell.

9. An apparatus, configured to:
receive, from a Base Station (BS), a blind Handover (HO) list and a plurality of parameters corresponding to a plurality of neighboring cells associated with a serving cell in connection with the BS, wherein the plurality of parameters comprises an initial weight associated with each of the plurality of neighboring cells in the blind HO list;
compute a rank for each of the plurality of neighboring cells in the blind HO list based on the plurality of parameters;
update the initial weight associated with each of the plurality of neighboring cells in the blind HO list based on the corresponding computed rank; and
update the blind HO list based on the updated weight associated with each of the plurality of neighboring cells.

10. The apparatus as claimed in claim 9, wherein the apparatus is further configured to:
transmit, to the BS, the updated blind HO list to perform a HO.

11. The apparatus as claimed in claim 9, wherein prior to receiving the blind HO list and the plurality of parameters, the apparatus is configured to:
transmit, to the BS, a subscription request to receive the blind HO list and the plurality of parameters.

12. The apparatus as claimed in claim 9, wherein the apparatus is configured to receive, from the BS, the plurality of parameters after an expiry of a predefined periodic timer at the BS.

13. The apparatus as claimed in claim 9, wherein the apparatus is configured to receive, from the BS, the blind HO list when the updated weight associated with each of the of the plurality of neighboring cells is zero.

14. The apparatus as claimed in claim 10, wherein the apparatus is configured to receive, from the BS, the plurality of parameters in a RIC indication response.

15. The apparatus as claimed in claim 10, wherein the apparatus is further configured to transmit, to the BS, the updated blind HO list to perform the HO in a RIC control request.

16. The apparatus as claimed in claim 9, wherein the plurality of parameters further comprises at least one of HO statistics, a number of User Equipment (UEs) attached to the cell, Physical Resource Block (PRB) utilization, and a total data throughput of the cell.

17. The apparatus as claimed in claim 9, wherein the apparatus corresponds to a Radio Access Network (RAN) Intelligent Controller (RIC).

18. A non-transitory computer-readable medium storing instructions, the instructions comprising: one or more instructions that, when executed by a RIC, the RIC comprising one or more processors, cause the one or more processors to:
receive, from a Base Station (BS), a blind Handover (HO) list and a plurality of parameters corresponding to a plurality of neighboring cells associated with a serving cell in connection with the BS, wherein the plurality of parameters comprises an initial weight associated with each of the plurality of neighboring cells in the blind HO list;
compute a rank for each of the plurality of neighboring cells in the blind HO list based on the plurality of parameters;
update the initial weight associated with each of the plurality of neighboring cells in the blind HO list based on the corresponding computed rank; and
update the blind HO list based on the updated weight associated with each of the plurality of neighboring cells.

19. The non-transitory computer-readable medium as claimed in claim 18, wherein the instructions cause the one or more processor to:
transmit, to the BS, the updated blind HO list to perform a HO.

20. The non-transitory computer-readable medium as claimed in claim 18, wherein the plurality of parameters further comprises at least one of HO statistics, a number of User Equipment (UEs) attached to the cell, Physical Resource Block (PRB) utilization, and a total data throughput of the cell.
